(19) United States
(12) Patent Application Publication
(10) Pub. No.: US 2009/0144957 A1
(43) Pub. Date: Jun. 11, 2009

(54) Removal tool

(76) Inventor: Eugene Rytlewski, Midland, MI (US)

Correspondence Address: MCKELLAR IP LAW, PLLC, 784 SOUTH POSEYVILLE ROAD, MIDLAND, MI, 48640, US

(21) Appl. No.: 12/315,404

(22) Filed: Dec. 3, 2008

Related U.S. Application Data
(63) Continuation-in-part of application No. 11/982,038, filed on Nov. 1, 2007.

(51) Int. Cl. B23P 19/04

(52) U.S. Cl. 29/267

(57) ABSTRACT

A removal tool for the removal of a base plate or a kick plate. Often when cleaning or moving display units it is required that the bottom plate or kick plate are removed. This requires workers to get down on the floor or bend over from a standing position to remove this plate. The instant invention allows the user to remove this plate without bending or getting down on the floor. The device is slide under the edge of the kick plate until it engages the barbed portion. Once the barb is behind the plate, pressure is placed against the shaft forcing the kick plate to pop out of its position and then it is readily removed from a disconnected position on the floor.

This application is a Continuation-In-Part claiming priority from U.S. Utility patent application Ser. No. 11/982,038 filed on Nov. 1, 2007.

The invention disclosed and claimed herein deals with a removal tool. In the process of removing kick plates and other panels from furniture fixtures it becomes inconvenient to use hand tools to pry these panels loose. It also requires that the removal process take place while working from the floor. The instant device eliminates the preceding problems by allowing one to quickly and easily remove these panels from a standing position saving time and potential for injury.

### BACKGROUND OF THE INVENTION

The use of pry or pinch bars is not new to the art. However, the use of a pry bar or removal tool that incorporates a barbed edge within the inner surface of the arcuate end of the bar, and its position relative to the an elongated shaft, is new to the art.

### THE INVENTION

The instant invention is a unitary removal tool comprising an elongated shaft having a linear axis and an arcuate portion, the arcuate portion ending in a barbed portion, wherein the arcuate portion is bent in a plane of from 80° to 95° from the linear axis.

### BRIEF DESCRIPTION OF THE DRAWINGS

FIG. 1 is a side view of the removal tool.

FIG. 2 is an expanded view of the arcuate portion showing the barbed portion.

FIG. 3 is a side view of the removal tool placed behind the kick plate.

FIG. 4 is a side view of the removal tool after the plate has been removed.

### DETAILED DESCRIPTION OF THE DRAWINGS

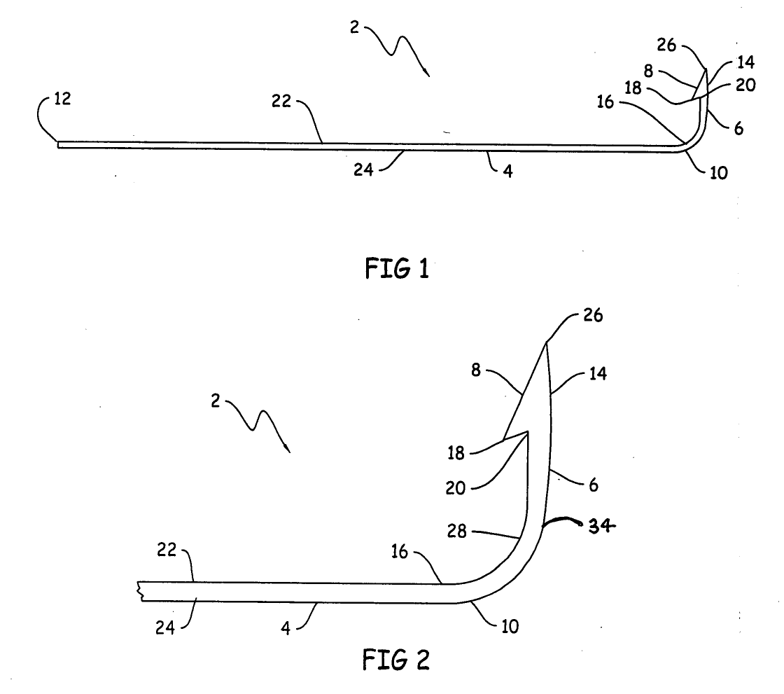

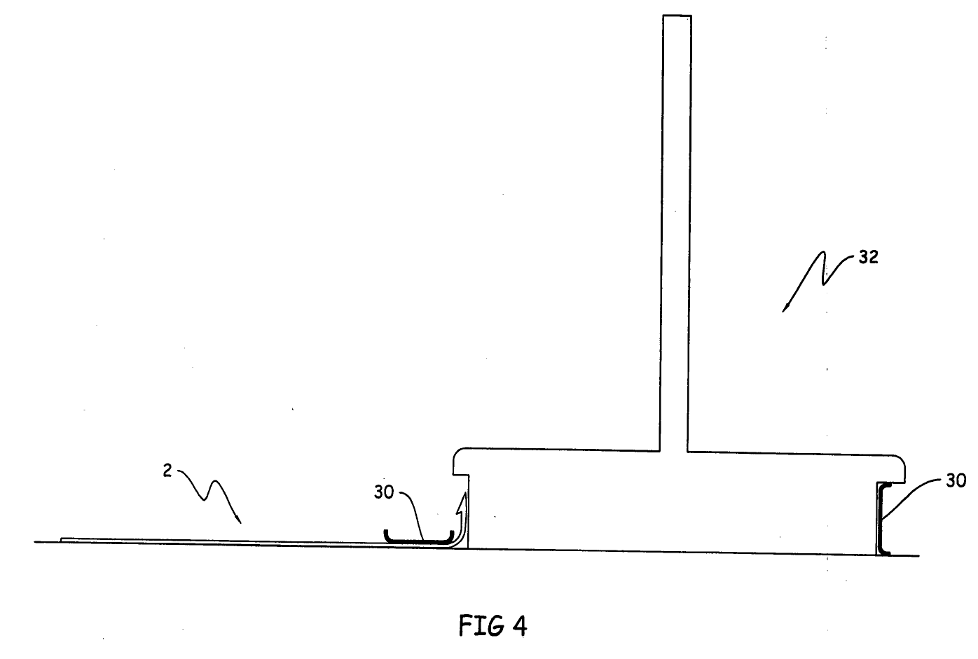

FIG. 1 is a side view of the removal tool 2. The instant invention is a removal tool 2 that comprises an elongated shaft 4 that has a near end 10 and a distal end 12. The near end 10 of the shaft 4 ends in an arcuate portion 6. The arcuate portion 6 has near end 14 and a distal end 16. Near the near end 14 of the arcuate portion 6 is a barbed portion 8. The terminus 26 of the barb is able to slide under the front edge of a kick panel 30 of furniture fixture 32 (FIG. 4) and the barbed portion 8 retains the kick panel 30 and when pressure is applied to the removal tool 2 along the bottom surface 34 of the removal tool 2, against the floor, the kick panel 30 will pop out of position and be pulled from its set position. The operation does not require the worker to get down on their knees to remove the panels. This saves time and the potential for injury related to bending of leg and back. This is possible because of the limited bent position of the arcuate portion in the range of 80° to 95° of the linear axis of the elongated shaft 4.

If the hooks of the prior art have too much bend, that means that they cannot easily be positioned under the panel. Also, the tool of the instant invention allows the outside surface of the arcuate portion to have a flatter plane, which in turn allows for more leverage on the panel to be removed.

FIG. 2 is an enlarged view of the arcuate portion 6 showing the barbed portion 8. This enlarged view shows the barbed portion 8 showing how the removal tool 2 hooks under the edge of a kick plate allowing for its quick and safe removal. The terminus 26 and the near end 14 of the arcuate portion 6 is slid under and behind the kick plate 30, past the barbed portion 8. The barbed portion 8 near end 18 and distal end 20 form the barb 8 or hook that engages the kick plate. Also shown is the distal end 16 of the arcuate portion 6. The shaft 4 has both a top surface 22 and a bottom surface 24. The user then pulls backward on the distal end 12 of the shaft 4. The arcuate portion 6 puts pressure against the kick plate 30 from the back side and pops it out of place for removal. Also the inside surface 28 of the arcuate portion 6 is shown.

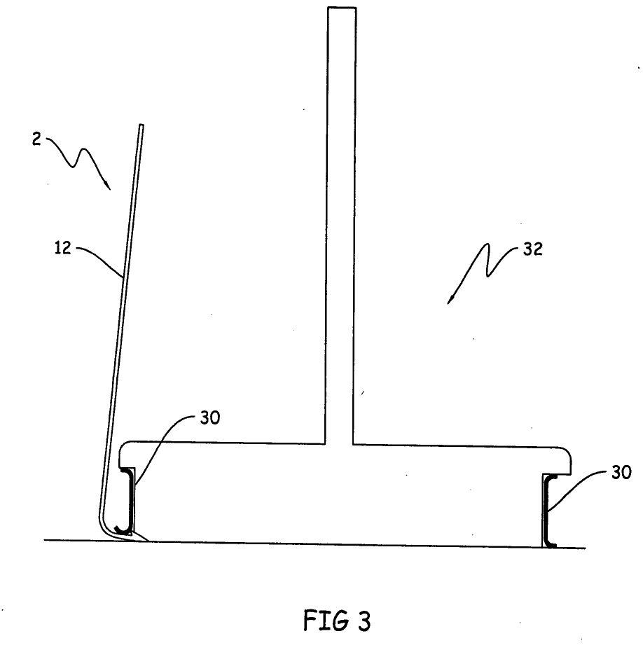

FIG. 3 is a side view of the removal tool 2 placed behind the kick plate. Once the removal tool 2 is placed behind the kick plate 30 the shaft 12 is pulled backward (towards the operator) removing the plate 30.

FIG. 4 is a side view of the removal tool 2 after the plate 30 has been removed.

The removal tool saves time by allowing the worker to remove the kick plate 30 without getting down on the floor or bending over. This will also reduce cost to employers because employees will not have to risk potential injury to the back and knees when performing the removal of a kick plate. Again the tool is operated from a standing position slid under the edge of a kick plate 30 then the kick plate 30 is simply pried off or popped out of its original position.

The tool has sufficient length between the arcuate portion and the barbed portion specifically to allow the tool to slide under the edge of the kick plate as the tool remains in a vertical position. Once in place the handle is pulled away from the display unit forcing the panel to pop off of the unit quickly and easily.

What is claimed is:

1. A unitary removal tool comprising:
an elongated shaft having a linear axis and an arcuate portion, said arcuate portion ending in a barbed portion, wherein the arcuate portion is bent in a plane of from 80° to 95° from the linear axis.

2. A removal tool as claimed in claim 1 wherein said tool is manufactured from metal.

3. A removal tool as claimed in claim 1 wherein said length of the shaft is in the range of 1 to 6 feet.
